(19) United States
(12) Patent Application Publication
(10) Pub. No.: US 2024/0133445 A1
(43) Pub. Date: Apr. 25, 2024

(54) Assembly Arrangement

(71) Applicant: Sumitomo Riko Company Limited, Aichi (JP)

(72) Inventors: Malek Lang, Steinau (DE); Ilknur Eken, Fulda (DE); Christopher Settnik, Sinntal (DE); Martin Gromes, Steinau (DE)

(73) Assignee: Sumitomo Riko Company Limited, Aichi (JP)

(21) Appl. No.: 18/494,500

(22) Filed: Oct. 24, 2023

(30) Foreign Application Priority Data
Oct. 24, 2022 (DE) 102022128208.2

(51) Int. Cl. F16F 15/04

(52) U.S. Cl. CPC F16F 15/04

(57) ABSTRACT

The invention relates to an assembly arrangement for assembling a component on an assembly environment in a vibration-damping way, comprising an abutment portion at the component end, an abutment portion at the environment end and a damping portion, wherein the damping portion is shaped in accordance with an at least approximately periodic function.

### RELATED APPLICATION DATA

This application claims the priority of the German patent application DE 10 2022 128 208.2, filed on Oct. 25, 2022 with the German Patent and Trademark Office, which is hereby incorporated in its entirety by reference.

### FIELD OF THE INVENTION

The present invention relates to an assembly arrangement for assembling a component on an environment, comprising the following features: an abutment portion at the component end; an abutment portion at the environment end; a damping portion between the abutment portion at the component end and the abutment portion at the environment end, wherein the damping portion exhibits a shape which at least approximates a periodic function, wherein bearing surfaces which form the abutment portions are formed in the region of the maximum amplitudes of the at least approximately periodic function. Such an assembly arrangement is in particular suitable for assembling a component on a vehicle frame in a vibration-damping way.

### BACKGROUND OF THE INVENTION

Assembly arrangements have been disclosed by the prior art in which abutting regions which are offset over the circumference are fixed to the component to be assembled on the one hand and to the assembly environment on the other. These regions function like a disk spring due to the damping characteristic of the plastic and/or the material from which such assembly arrangements are molded. The abutting regions which are offset over the circumference can compensate for a thrust load, wherein low spring rates are achieved, with acceptable aging characteristics. For good damping characteristics, it is preferable for such an assembly arrangement to have as large a working region as possible, wherein the assembly arrangement which is in principle designed as a disk spring is functionally sub-divided into a working region and a propagation region. The working region should be as large as possible in order to achieve natural resonances of the assembly arrangement which are as low as possible. Using the principles of a disk spring allows an acceptable working region and therefore acceptable damping characteristics, with equally acceptable aging.

JP 6895141 B discloses an assembly arrangement which comprises two abutment portions which are connected to each other by stays. In this case, the damping characteristic is likewise achieved in principle using the principle of a disk spring.

### SUMMARY OF THE INVENTION

It is the object of the present invention to provide an assembly arrangement which can exhibit better damping characteristics and better aging characteristics, with substantially the same space requirements and substantially the same materials.

In accordance with the invention, the assembly arrangement for assembling a component on an environment is formed to comprise an abutment portion at the component end, an abutment portion at the environment end and a damping portion between the abutment portion at the component end and the abutment portion at the environment end, wherein the material of the damping portion exhibits a shape which resembles an at least approximately periodic function, wherein bearing surfaces to be assigned to the abutment portions are formed in the region of the maximum amplitudes of the at least approximately periodic function. In the simplest case, the damping portion exhibits a wave spring-like design, wherein it can also as applicable be essential for said assembly arrangement in accordance with the invention to preferably be able to be formed in one piece from at least one and preferably one plastic material.

The bearing surfaces can advantageously be flattened, i.e. the regions of the maximum amplitudes of the shape of the damping portion can be flattened. They can also be embodied as bearing surfaces and/or abutment portions beyond the maximum amplitudes.

It is then essential for the shape of the damping portion, which advantageously encircles the entire circumference of the assembly arrangement which is preferably shaped so as to exhibit cylindrical symmetry, to extend substantially constantly.

The periodic function can be a sine function or a cosine function, wherein substantial deviations should hardly need to be taken into account due to the continuity in the shape of the damping portion over the circumference of the damping portion.

The periodic function should advantageously be dimensioned such that it provides at least two, preferably at least three, amplitudes over the circumference of the damping portion, wherein said amplitudes can provide bearing surfaces and therefore abutment portions, preferably in the positive and negative amplitude propagation direction.

As already indicated, it is advantageous for the assembly arrangement in accordance with the invention to be configured to be at least approximately cylindrical, wherein a hollow-cylindrical, continuous cavity is provided, via which the assembly arrangement can be fixed to the assembly environment.

In order to be able to advantageously fix the assembly arrangement and therefore a component, an additional contact ring can be provided which is likewise formed so as to exhibit cylindrical symmetry and which can be inserted into the hollow-cylindrical, continuous cavity via a pipe socket-like and/or cylindrical appendage, wherein the geometries of the assembly arrangement and the pipe socket-like appendage are mutually adjusted, such that the desired damping characteristic and/or wave spring characteristic is not impaired in a circumferential contact region between the assembly arrangement and the pipe socket-like appendage which is likewise formed so as to exhibit cylindrical symmetry, i.e. the contact surface of the contact ring in relation to the bearing surfaces and/or abutment portions.

Preferably, the contact ring and its cylindrical and/or pipe socket-like appendage likewise comprise a cylindrical hollow space which is continuous and through which a screw bolt or the like can be guided in order to be fixed to the assembly environment, wherein the screw bolt or the like extends from the upper end of the assembly arrangement as far as the assembly environment, such that in this way the component which is to be fixed can be fixed to the assembly environment, such as a vehicle portion, vehicle frame or the like.

Since the damping characteristics of the assembly arrangement can also be influenced by the material, the material for the damping portion is advantageously selected such that a vibration spectrum of the component which is to be damped is preferably absorbed, wherein a size and/or geometry of the bearing surfaces and therefore the abutment portion could in particular likewise be adapted.

The damping portion is advantageously formed in one piece with at least one and preferably both abutment portions, but can also be embodied as a separate portion, wherein this incurs a greater assembly expenditure on the one hand, but on the other enables a possibly more favorable material selection to be made in relation to the different portions of the assembly arrangement in accordance with the invention.

The portions of the assembly arrangement are in particular formed to be substantially cylindrical and preferably formed integrally, wherein they provide a cylindrical, continuous hollow space along a cylinder axis of the assembly arrangement when held together.

In order to advantageously facilitate centering during assembly in the assembly environment, for example a circular or substantially circular hole in a vehicle frame, the assembly arrangement in accordance with the invention can comprise one or preferably three circumferential arc-shaped contact surfaces, radially on the outer circumference, which center the assembly arrangement in the assembly environment when held together and/or as an integrally formed arrangement. It is of course also possible to form two, four or more such contact devices.

### BRIEF DESCRIPTION OF THE DRAWINGS

The present invention is described in more detail below on the basis of example embodiments with reference to the attached figures, wherein identical reference signs denote identical components, such that the constituent parts in the figures need not all be described repeatedly.

FIGS. 1A to 1D show a first embodiment of the assembly arrangement in accordance with the invention in a front view (FIG. 1A), a view from the right (FIG. 1B), a view from above (FIG. 1D) and a view from below (FIG. 1C).

FIG. 1E shows an example embodiment in principle of a shape of a damping portion of an embodiment in accordance with the invention.

FIG. 2 shows a plan view onto an assembly arrangement in accordance with an embodiment of the invention.

FIG. 3 shows an embodiment of an assembly arrangement in a perspective side view, abutting a contact ring.

FIG. 4 shows a section through the embodiment in accordance with FIG. 3.

FIG. 5 shows an assembly situation for an assembly arrangement in accordance with the invention.

FIG. 6 shows a diagram which shows a decoupling characteristic across a conventional assembly arrangement.

FIG. 7 shows a diagram which shows a decoupling characteristic across an assembly arrangement in accordance with the present invention.

FIGS. 8a and 8b show a schematic profile of the contours of a waveform of a damping portion with reference to an equation incorporated into FIG. 8b.

### DETAILED DESCRIPTION

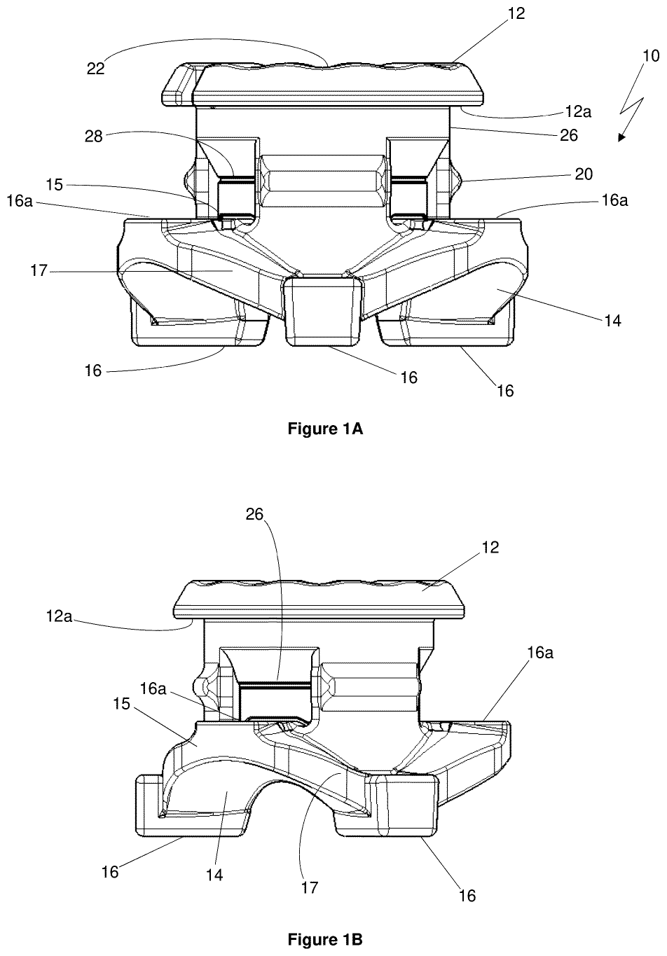

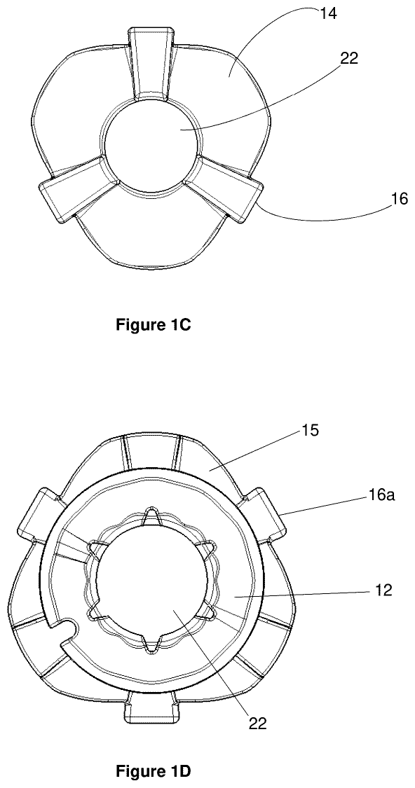

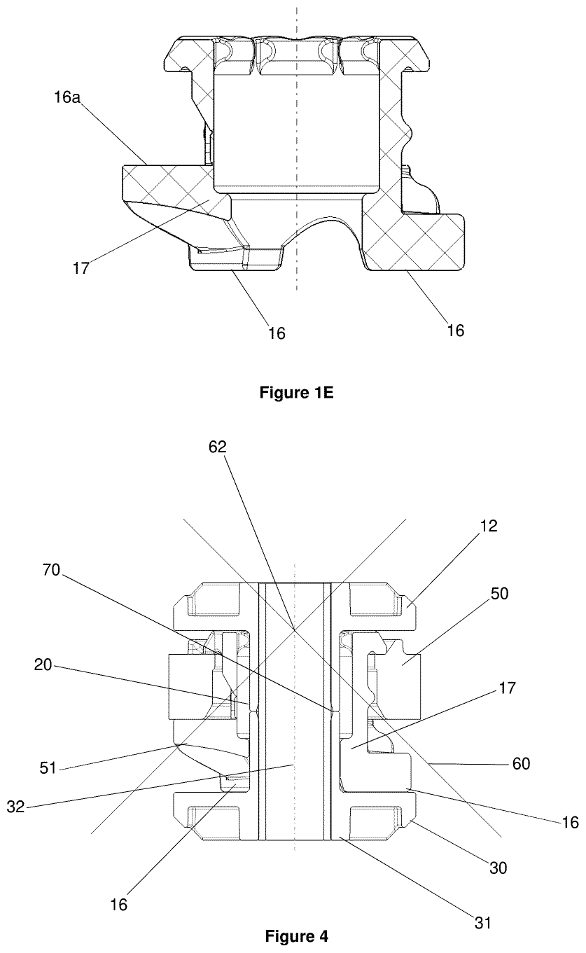

The embodiment of an assembly arrangement in accordance with the invention in accordance with FIGS. 1A to 1D is denoted in general terms by the reference sign 10.

The assembly arrangement 10 comprises an abutting region 12 featuring a counter bearing region 12a which is designed to be moved into contact with a component to be assembled or with a support of said component. The abutting region 12 exhibits a central opening 22 through which a connecting device, such as a screw bolt, can be inserted in the assembly situation. Centering contact surfaces 20 are provided in the cylinder region 26 in order to center the assembly arrangement in the component and/or in an opening, for example a circular opening, in a support for the component. The upper abutting region 12 can be connected to a damping portion 17 in accordance with the invention by a connecting device 28, such as a latch 28, wherein the component or the support at the component end can be fixed to the assembly arrangement. A screw connection or the like could also be considered in this case.

The damping portion 17 is embodied as an at least approximately periodic function and accordingly exhibits an upper waveform 15 at the component end and a lower waveform 14 at the environment end. Maximum amplitudes of this periodic waveform or function are characterized by bearing surfaces 16 and 16a which form an abutment portion 16 at the environment end and an abutment portion 16a at the component end.

In other words, the approximately periodic function, the shape of which corresponds to the damping portion 17, forms a sort of wave spring in which the maximum amplitudes 16a at the component end form the abutment portion 16a at the component end. The abutment portion 16 at the environment end is formed by the maximum negative amplitudes which correspond to the bearing surfaces 16 and/or abutment portion 16, wherein the assembly arrangement 10 can be formed from a polymeric material, such as a plastic from the group containing PE, PP, PVC, PS, PMMA, etc. The constituent parts can be manufactured by injection molding, casting or the like. Metals can also be used in part, if for instance certain damping characteristics and/or spring characteristics are required. Injection molding the damping portion 17 from aluminum can also then be considered. Other materials, such as for example sheet steel, can also be considered, in particular for specific applications.

FIG. 1B shows how the abutment portions 16 at the environment end extend slightly beyond the maximum amplitude of the waveform of the approximately periodic functions of the damping portion 17. Correspondingly, the bearing surfaces 16a of the abutment portion 16a at the component end also extend slightly beyond the approximately periodic function of the shape of the damping portion 17.

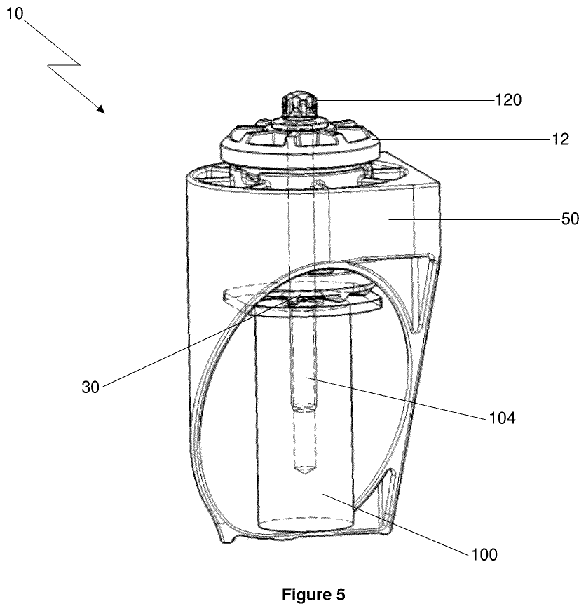

The cylindrically formed hollow space 22 is in particular revealed in FIG. 1C. On the one hand, a pipe socket-like appendage 32 of a contact ring 30 (see FIG. 4) can be inserted into this cylindrically formed hollow space 22 of the assembly arrangement 10, which is advantageously formed cylindrically in general terms, and on the other, a screw bolt 102 (see FIG. 5) can be used to fix a complete assembly arrangement 10 and therefore a component 50 (see FIGS. 3 to 5).

FIG. 1D shows the assembly arrangement 10 from above and illustrates how three maximum amplitudes 16a having a certain radial extent are provided in the direction of the component and/or a support of the component 50. Together they form the abutment portion 16a at the component end. It is of course also possible in this case to form four, five or more bearing surfaces 16a which as a whole can then form the abutment portion 16a at the component end. The same applies to the bearing surfaces 16 at the environment end and therefore to the abutment portion 16 at the environment end.

FIG. 1E shows a damping portion 17 of an embodiment in accordance with the invention. In this case, the damping portion 17 is shown even more closely as a periodic function, wherein bearing surfaces 16, 16a are formed at the maximum negative and positive amplitudes of this function. The damping portion 17 is preferably formed such that one side 17a of the damping portion 17 transitions continuously into the other side 17b when the shape of the damping portion 17 shown is formed over the circumference of the substantially cylindrical assembly arrangement in an actual embodiment.

Discontinuities can of course also be provided, i.e. a step can be provided between the side 17a and the side 17b of the damping portion 17 in accordance with FIG. 1E, although this can lead to a sub-optimum damping characteristic and more rapid aging of the assembly arrangement.

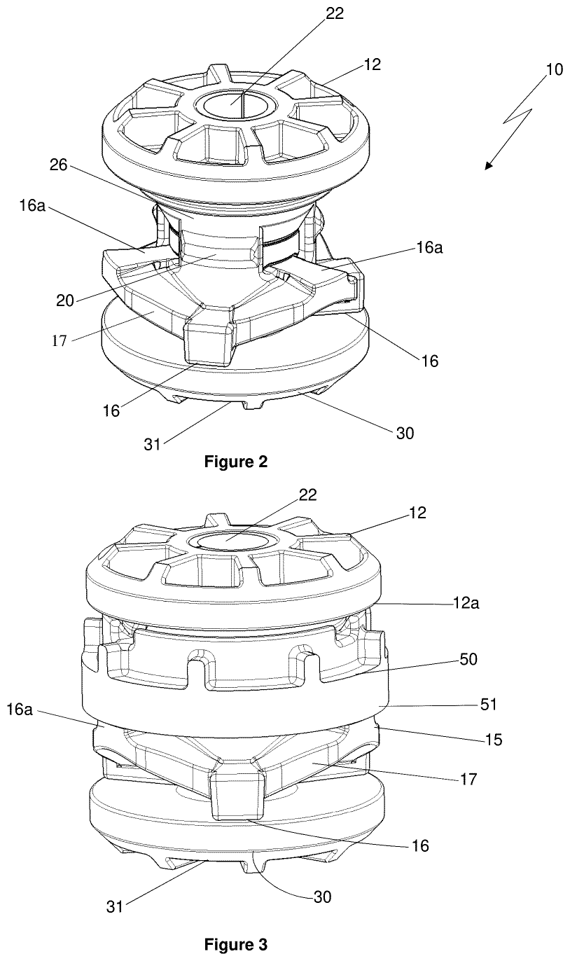

FIG. 2 shows an embodiment of an assembly arrangement 10 in accordance with the present invention, in which the bearing surfaces 16, 17a are dimensioned to be larger in order to achieve a larger working region for the damping portion 17. The centering contact surfaces 20 extend over a circumferential arc, i.e. over a comparatively large circumferential region, in order to achieve an advantageous characteristic when centering the assembly arrangement within an opening in a component support and/or a component to be assembled.

FIG. 3 shows how a support 50 and/or a component 50 to be assembled is held in relation to the assembly arrangement 10 in accordance with the invention. The support 50 and/or the component 50 is held on the counter bearing region 12a of the abutting region 12, and its flange-like region 51 rests on the bearing surfaces 16a. The lower bearing surfaces 16 of the damping portion 17 rest on the contact ring 30, the abutting surface 31 of which faces the assembly environment 100 (see FIG. 5).

FIG. 4 shows how the contact ring 30 is placed into the central opening 22 in the substantially cylindrical assembly arrangement 10 via a cylindrical and/or pipe socket-like extension 32. A corresponding contour of the assembly arrangement 10 abuts against the pipe socket-like formation 32 of the contact ring 30 via a contact line 70. In order to influence a damping characteristic of the arrangement 10, a free space can also be provided at the contact line 70.

This enables an axial spring rate to be set substantially by the shape of the damping portion 17, an at least approximately periodic function, while a radial spring rate can be provided by the geometry and thickness of the contact ring 30 and its pipe socket-like extension 32.

FIG. 5 shows an installation situation, for example in a vehicle. As is shown, the contact ring 30 rests on the vehicle frame. A support 50 which bears a component (not shown) is held by the abutting region 12 on the one hand and by the damping portion 17 (see FIG. 4) on the other. A screw bolt 102 is fixed in a threaded opening and/or threaded bore 104 of the vehicle frame and clamps the overall arrangement consisting of the assembly arrangement 10 in accordance with the invention and the contact ring 30.

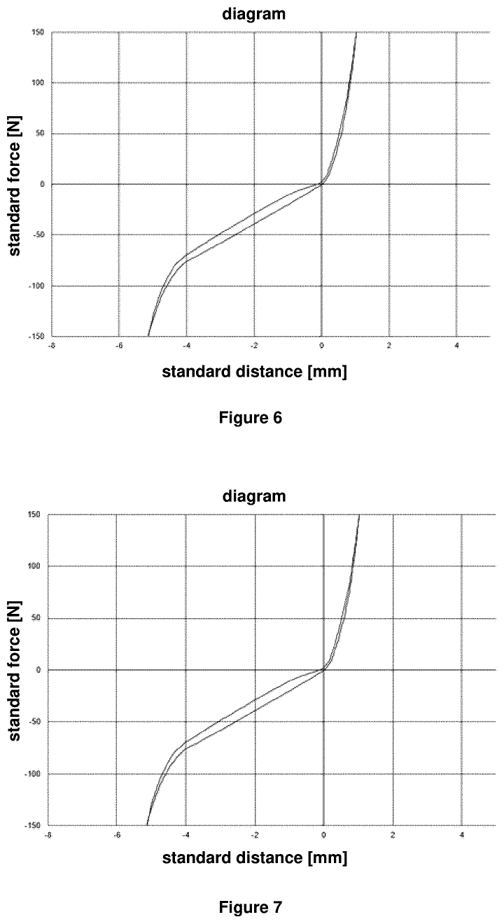

A diagram in accordance with FIG. 6 also shows, with reference to FIG. 4 and FIG. 7, how a conventional assembly arrangement which corresponds to the disk spring principle provides a comparatively small working region which correspondingly provides a lesser damping characteristic and/or spring rate. FIG. 4 shows how the assembly arrangement in accordance with the invention is able to provide a larger working region, which is shown symbolically by the straight lines 60 which meet at an intersection point 62.

The larger working region which results in accordance with FIG. 4, and which can be achieved with the dimensions remaining otherwise identical, provides a larger axial spring rate and therefore improved damping characteristics and improved aging characteristics.

It should also be stated in relation to the assembly arrangement in accordance with the invention that higher spring rates can be achieved for the bearing surfaces, i.e. the abutment portions 16, 16a, due to their larger areas, wherein the weight of a component to be assembled also needs to be taken into account. If the unit to be assembled is larger, the amplitude of the damping portion 17 also needs to be increased in order to increase the spring rate. This can also be accompanied by an increase in the bearing surface in the region of the amplitude.

The bearing surfaces can be formed in one piece with the damping portion 17 or can also be integrally molded from a different material, i.e. a polymeric material such as has already been described in the present disclosure can be used to form both component parts. Elastomers such as for example silicone or natural rubber can however also be used.

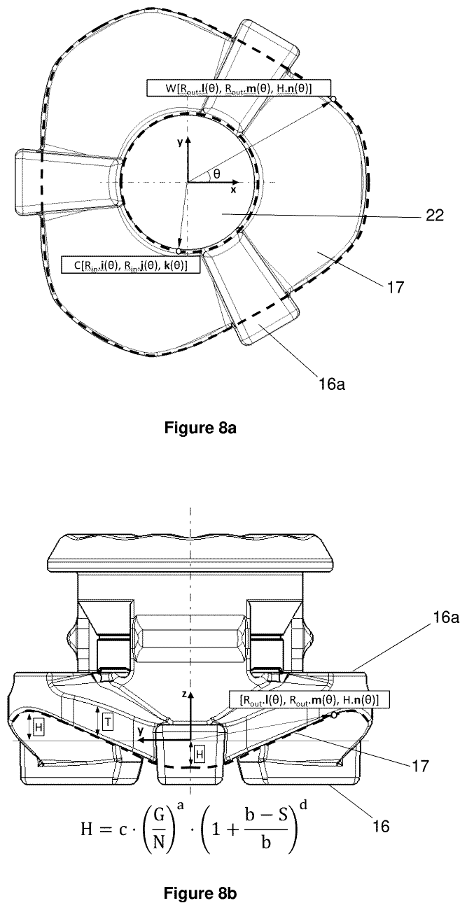

FIGS. 8a and 8b show an embodiment of a damping portion 17 of an assembly arrangement 10 in accordance with the invention. This schematic representation makes reference to the following formula:

$$H = c \cdot {( \frac{G}{N} )}^{a} \cdot {( 1 + \frac{b - S}{b} )}^{d}$$

In this formula and/or equation, the height amplitude H corresponds to the contour profile of the damping portion 17. G≤150 represents the weight in kg of the entire decoupled system. N≥3 is the number of mounting positions of the system, i.e. in particular the number of bearing surfaces and/or abutment portions 16 and/or 16a, for example three or more on the side of the abutment portion 16a at the component end and three or more on the side of the abutment portion 16 at the environment end. The number N can also be different between the two abutment portions, wherein the given formula would then need to be correspondingly adapted. 30≤S≤70 is the average hardness in Sh(A) of all the elastomers in the mounting system. Also, 0.2≤a≤0.3, b=38.7±1, 0.2≤c≤0.5 and 1.1≤d≤1.5 are the mounting and system parameters. Deviations from the cited values are of course tolerable if they do not reduce the desired damping characteristic too significantly. A finite element method was used for development.

FIGS. 8a and 8b show how the damping portion of the assembly arrangement 10, which is preferably made from an elastomer, exhibits a luminal wall thickness, an inner contour C and an outer contour W. Periodic functions can be used to describe the profile of the inner contour C and outer contour W of the damping portion 17 on the basis of the angular position θ with reference to the radius R and the amplitude H.

Although the invention has been shown and described with respect to one or more particular preferred embodiments, it is clear that equivalent amendments or modifications will occur to the person skilled in the art when reading and interpreting the text and enclosed drawing(s) of this specification. In particular with regard to the various functions performed by the elements (components, assemblies, devices, compositions, etc.) described above, the terms used to describe such elements (including any reference to a “means”) are intended, unless expressly indicated otherwise, to correspond to any element which performs the specified function of the element described, i.e. which is functionally equivalent to it, even if it is not structurally equivalent to the disclosed structure which performs the function in the example embodiment(s) illustrated here. Moreover, while a particular feature of the invention may have been described above with respect to only one or some of the embodiments illustrated, such a feature may also be combined with one or more other features of the other embodiments, in any way such as may be desirable or advantageous for any given application of the invention.

1. An assembly arrangement for assembling a component on an environment, comprising the following features:
an abutment portion at the component end;
an abutment portion at the environment end;
a damping portion between the abutment portion at the component end and the abutment portion at the environment end,
wherein the damping portion exhibits a shape which at least approximates a periodic function, wherein bearing surfaces which form the abutment portions are formed in the region of the maximum amplitudes of the at least approximately periodic function.

2. The assembly arrangement according to claim 1, wherein the damping portion exhibits a wave-like design.

3. The assembly arrangement according to claim 1, wherein the bearing surfaces are embodied as flattened bearing supports on the regions of the maximum amplitudes of the at least approximately periodic function.

4. The assembly arrangement according to claim 1, wherein the periodic function is a sine function or cosine function.

5. The assembly arrangement according to claim 1, wherein the periodic function provides at least two maximum amplitudes in both the positive and negative direction of the periodic function over the circumference of the damping portion.

6. The assembly arrangement according to claim 5, wherein the periodic function provides at least three maximum amplitudes in both the positive and negative direction of the periodic function over the circumference of the damping portion.

7. The assembly arrangement according to claim 1, wherein it is configured to be at least approximately cylindrical.

8. The assembly arrangement according to claim 1, wherein a hollow-cylindrical, continuous cavity is provided, via which the assembly arrangement can be fixed.

9. The assembly arrangement according to claim 1, wherein a material for the damping portion is selected such that a vibration spectrum of the component which is to be damped is absorbed.

10. The assembly arrangement according to claim 9, wherein a size and/or geometry of the bearing surface and/or a size of the maximum amplitude can be set.

11. The assembly arrangement according to claim 1, wherein the damping portion is formed in one piece with the abutment portions or is embodied as a separate portion.

12. The assembly arrangement according to claim 1, wherein the assembly arrangement further comprises a contact ring which engages a cylindrical passage opening of the assembly arrangement via a cylindrical appendage.

13. The assembly arrangement according to claim 1, wherein a cylinder region is molded onto the damping portion in the axial direction of the substantially cylindrical shape of the damping portion.

14. The assembly arrangement according to claim 1, wherein an abutting region can be placed on the damping portion and/or the cylinder region.

15. The assembly arrangement according to claim 14, wherein at least one circumferential arc-shaped contact surface is provided radially on the outer circumference of the cylinder region.

16. The assembly arrangement according to claim 15, wherein three circumferential arc-shaped contact surfaces are provided radially on the outer circumference of the cylinder region.

17. The assembly arrangement according to claim 1, wherein the periodic function which corresponds to the damping portion at least approximately follows a contour profile having a height amplitude H, wherein
$$H = c \cdot {( \frac{G}{N} )}^{a} \cdot {( 1 + \frac{b - S}{b} )}^{d} ,$$
G≤150 kg, N≥3 corresponds to the number of bearing surfaces and/or abutment portions, 30≤S≤70 corresponds to the average hardness in Sh(A) of all the elastomers in the mounting system, 0.2≤a≤0.3, b=38.7±1, 0.2≤c≤0.5 and 1.1≤d≤1.5.
